(19) United States
(12) Patent Application Publication
(10) Pub. No.: US 2013/0174828 A1
(43) Pub. Date: Jul. 11, 2013

(54) Systems and Methods For Controlling Surface Profiles Of Wafers Sliced In A Wire Saw

(71) Applicant: MEMC ELECTRONIC MATERIALS, SPA, Novara (IT)

(72) Inventors: Carlo Zavattari, Varallo Pombia (IT); Ferdinando Severico, Cavaglietto (IT); Sumeet S. Bhagavat, St. Charles, MO (US); Gabriele Vercelloni, Novara (IT); Roland R. Vandamme, Wentzville, MO (US)

(73) Assignee: MEMC ELECTRONIC MATERIALS, SPA, Novara (IT)

(21) Appl. No.: 13/707,867

(22) Filed: Dec. 7, 2012

Related U.S. Application Data
(60) Provisional application No. 61/568,785, filed on Dec. 9, 2011.

(51) Int. Cl. B28D 5/00

(52) U.S. Cl. CPC B28D 5/007
USPC 125/21

(57) ABSTRACT

Systems and methods are disclosed for controlling the surface profiles of wafers cut in a wire saw machine. The systems and methods described herein are generally operable to alter the nanotopology of wafers sliced from an ingot by controlling the shape of the wafers. The shape of the wafers is altered by changing the temperature and/or flow rate of a temperature-controlling fluid that comes in contact with the ingot. Different feedback systems can be used to determine the temperature of the fluid necessary to generate wafers having the desired shape and/or nanotopology.

### CROSS-REFERENCE TO RELATED APPLICATION

The present application claims the benefit of U.S. Provisional Application No. 61/568,785 filed Dec. 9, 2011, which is incorporated herein by reference in its entirety.

### FIELD

This disclosure relates generally to wire saw machines used to slice ingots into wafers and, more specifically, to systems for controlling the surface profiles of wafers sliced in the wire saw machines.

### BACKGROUND

Semiconductor wafers are typically formed by cutting an ingot with a wire saw machine. These ingots are often made of silicon or other semiconductor or solar grade material. The ingot is connected to structure of the wire saw by a bond beam and an ingot holder. The ingot is bonded with adhesive to the bond beam, and the bond beam is in turn bonded with adhesive to the ingot holder. The ingot holder is connected by any suitable fastening system to the wire saw structure.

In operation, the ingot is contacted by a web of moving wires in the wire saw that slice the ingot into a plurality of wafers. The bond beam is then connected to a hoist and the wafers are lowered onto a cart.

Wafers cut by known saws may have surface defects, such as warp, that cause the wafers to have nanotopology that deviates from set standards. In order to ameliorate the deviating nanotopology, such wafers may be subject to additional processing steps. These steps are time-consuming and costly. Moreover, known wire saw machines are not operable to adjust the shape and/or warp of the surfaces of the wafers cut from the ingot by the machines. Thus, there exists a need for a more efficient and effective system to control nanotopology of wafers cut in a wire saw machine.

This section is intended to introduce the reader to various aspects of art that may be related to various aspects of the disclosure, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

### SUMMARY

One aspect is a system for controlling the surface profile of wafers sliced from an ingot in a wire saw, the wire saw including a wire guide supporting wires. The system includes a containment box positioned vertically beneath the wires and configured to contain a slurry, and a slurry temperature control system configured to circulate slurry through the containment box.

Another aspect is a method for controlling the surface profile of wafers sliced from an ingot in a wire saw, the wire saw including a wire guide supporting wires. The method includes circulating slurry through a containment box positioned vertically beneath the wires, the slurry circulated using a slurry temperature control system, and immersing at least a portion of the ingot in the slurry after the at least a portion of the ingot passes through the wires.

Still another aspect is a system for controlling the surface profile of wafers sliced from an ingot in a wire saw, the wire saw including a wire guide supporting wires. The system includes a slurry temperature control system, and at least one nozzle in fluid communication with the slurry temperature control system and configured to spray slurry onto a surface of the ingot to facilitate reducing surface defects in the surface profile of the wafers sliced from the ingot.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 illustrates a wire saw slicing apparatus;

FIG. 2 illustrates a system for controlling wafer surface profiles;

FIG. 3 illustrates an alternative system for controlling wafer surface profiles;

FIG. 4 illustrates an alternative system for controlling wafer surface profiles;

FIGS. 5A and 5B are graphs demonstrating the efficacy of the system shown in FIG. 4; and

FIG. 6 illustrates an alternative system for controlling wafer surface profiles.

Corresponding reference characters indicate corresponding parts throughout the drawings.

### DETAILED DESCRIPTION

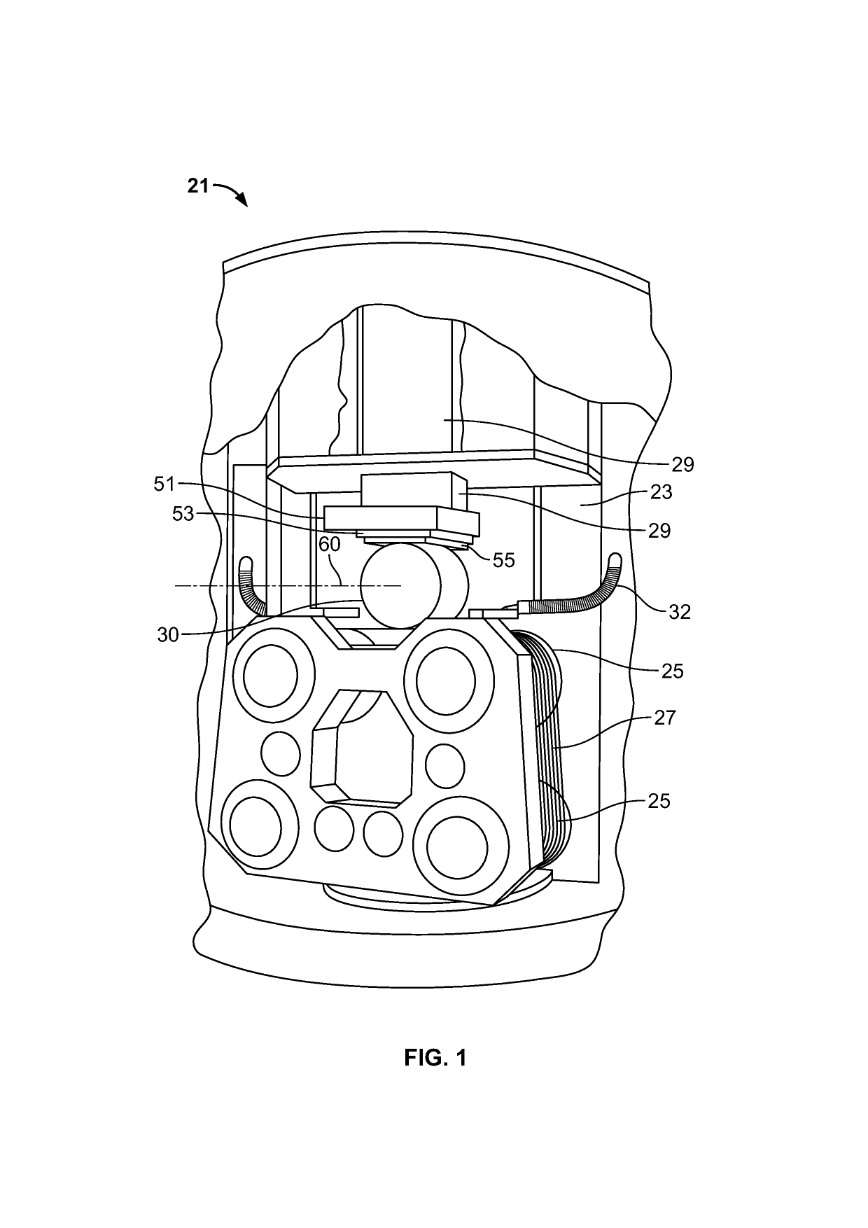

The present disclosure is directed to controlling surface profiles of wafers sliced using a wire saw slicing apparatus. An exemplary wire saw slicing apparatus for slicing a single crystal or polycrystalline silicon ingot into individual wafers is illustrated in FIG. 1, designated in its entirety by the reference numeral 21. Any suitable wire saw slicing apparatus may be utilized without departing from the scope of the present disclosure.

The apparatus generally includes a frame 23 which mounts four wire guides 25 (two are partially shown) for supporting a wire web 27. The frame also mounts a movable slide or head 29 which mounts an ingot 30 for movement relative to the frame for forcing an ingot 30 into the web.

The ingot 30 is typically a single crystal silicon ingot or polycrystalline silicon ingot, more typically a single crystal silicon ingot. Although single crystal silicon is a preferred material for semiconductor-grade wafers, other semiconductor materials may be used.

The wire guides 25 are generally cylindrical and have a number of peripheral grooves (not shown) that receive respective wire segments making up the wire web 27 and are spaced at precise intervals. The spacing between the grooves determines the spacing between wire segments and thereby determines the thickness of the wafers sliced from the ingot 30. The wire guides 25 rotate on bearings for moving the wire segments lengthwise or axially. A cutting-slurry is directed onto the wire web 27 by conduits 32.

In the wafer slicing operation for producing silicon wafers, the ingot 30 is mounted on an ingot holder 53, which is held in the wire saw slicing apparatus 21 by a table 51. The ingot 30 is adhered to a wire saw beam 55. The surfaces of the ingot holder 53 and the ingot 30 are adhered to the wire saw beam 55 using a suitable adhesive.

The ingot holder 53 may be constructed from steel or other materials, such as, for example, INVAR (an alloy of iron (64% ) and nickel (36% ) with some carbon and chromium).

To produce wafers, the ingot 30 is gradually lowered into the wire web 27 of fast moving, ultrathin wire. Cutting action is created by pouring abrasive slurry on the wire web 27, which is actually a single wire being fed from one spool to another. Immediately after slicing, the “as cut” wafers are cleaned in a series of chemical baths to remove any residual slurry. From here, the wafers are polished and cleaned.

Numerous mechanisms are believed to affect and/or cause entry marks formed on wafers as they are sliced from the ingot 30 by the wire saw slicing apparatus 21. For example, wire saw slicing generates frictional heat at the moving front representing the location of the cut. More specifically, during slicing of the ingot 30, the temperature of the ingot may increase from approximately 20° Celsius to approximately 55° Celsius.

The majority of this temperature increase occurs during the first part of the cut (i.e., when the wire web 27 initially contacts the ingot 30). The increase in temperature causes the ingot 30 to expand in a direction parallel to a longitudinal axis 60 of the ingot 30, and the expansion may cause variation and defects (i.e., warp) in a surface profile of the wafers produced by the slicing. For example, experimental data shows an expansion of the ingot 30 in the range of 40 nanometers (nm) along the longitudinal axis 60 of the ingot 30. Using the systems and methods disclosed herein, the temperature of the ingot is monitored and controlled to facilitate reducing expansion of the ingot 30 and to facilitate reducing surface defects in the produced wafers.

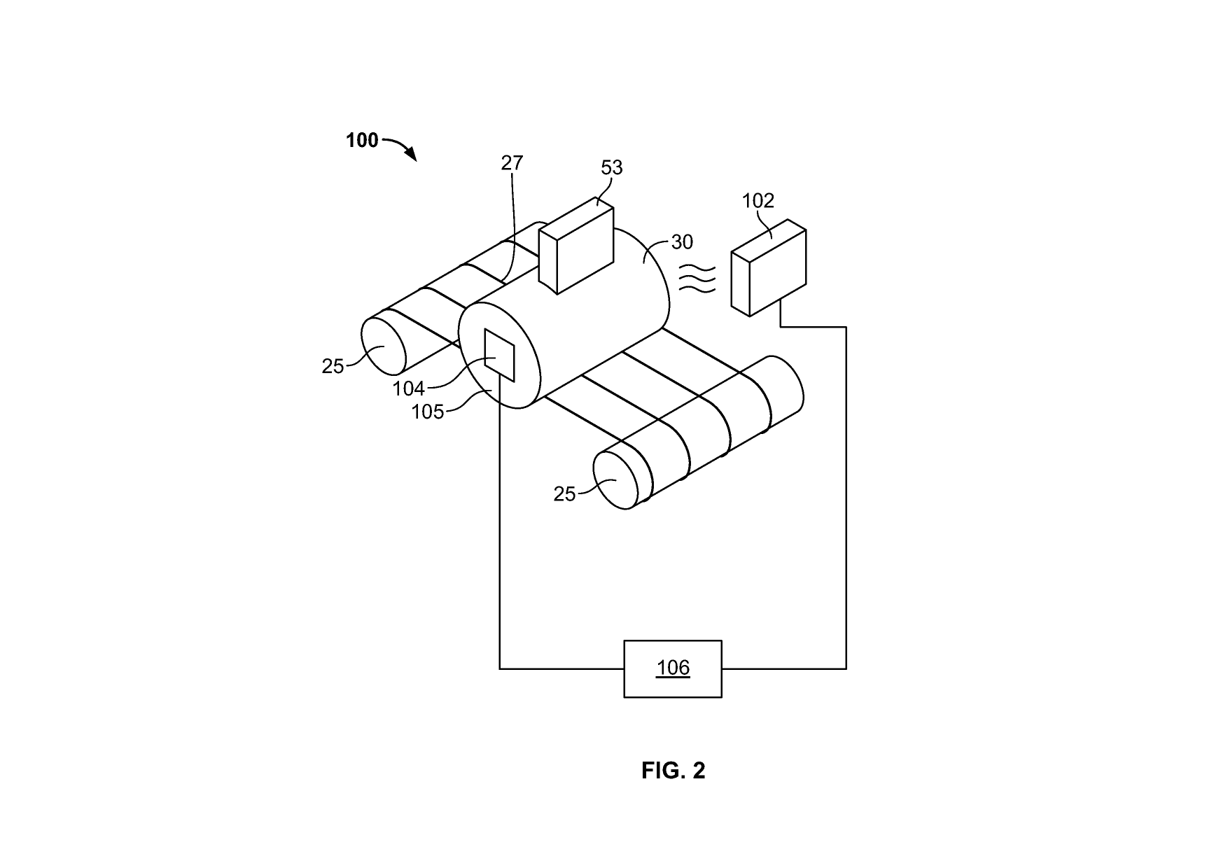

Referring to FIG. 2, a system for controlling wafer surface profiles is indicated generally by the reference numeral 100. In the exemplary embodiment, similar to the wire saw slicing apparatus 21 (shown in FIG. 1) the system 100 includes an ingot 30 and a wire web 27. The ingot 30 is suspended from an ingot holder 53. A wire saw beam (not shown) may couple the ingot 30 and the ingot holder 53. To produce a plurality of wafers, the ingot 30 is lowered into the wire web 27 such that the wires in the wire web 27 slice the ingot 30. As described above, by controlling the temperature of the ingot 30 during the slicing, surface defects in the sliced wafers may be reduced.

In the embodiment illustrated in FIG. 2, the ingot 30 is preheated to the top temperature it would otherwise reach during the slicing process. That is, before the ingot 30 is lowered into the wire web 27, the ingot may be heated to approximately 55° Celsius, for example. Accordingly, when the wire web 27 initially contacts the ingot 30, the temperature of the ingot 30 remains relatively unchanged, any expansion of the ingot 30 is relatively low, and surface defects are reduced.

The ingot 30 is preheated using a heating device 102. The heating device heats the surface of the ingot 30 initially, and it takes time for the heat to be transferred to interior regions of the ingot 30. Accordingly, adequate amounts of heat applied for sufficient amounts of time are used to thoroughly heat the ingot 30.

The heating device 102 may include an air gun, one or more resistors, a microwave, and/or any device suitable for preheating the ingot 30. In one example, the ingot was immersed in 60° Celsius water for four hours to heat the ingot to approximately 52° Celsius. In another example, the ingot was immersed in 60° Celsius water for twenty four hours to heat the ingot to approximately 56° Celsius.

In the example embodiment, the ingot 30 is not only preheated prior to applying the wire web, but the heating device 102 also heats the ingot 30 at least during the initial slicing by the wire web 27 to ensure the temperature of the ingot 30 remains substantially constant throughout the slicing process.

In the example embodiment, a temperature probe 104 is coupled to an end face 105 of the ingot 30. Alternatively, the temperature probe 104 may be coupled at any location within the system 100 that enables the temperature probe 104 to monitor the temperature of the ingot 30. A controller 106 is communicatively coupled to the temperature probe 104 and the heating device 102. The controller 106 receives signals from temperature probe 104 that are indicative of the temperature of the ingot 30. Based on the received signals, the controller 106 can control operation of the heating device 102 such that the ingot 30 remains at a substantially constant temperature throughout the slicing process, reducing surface defects in the produced wafers.

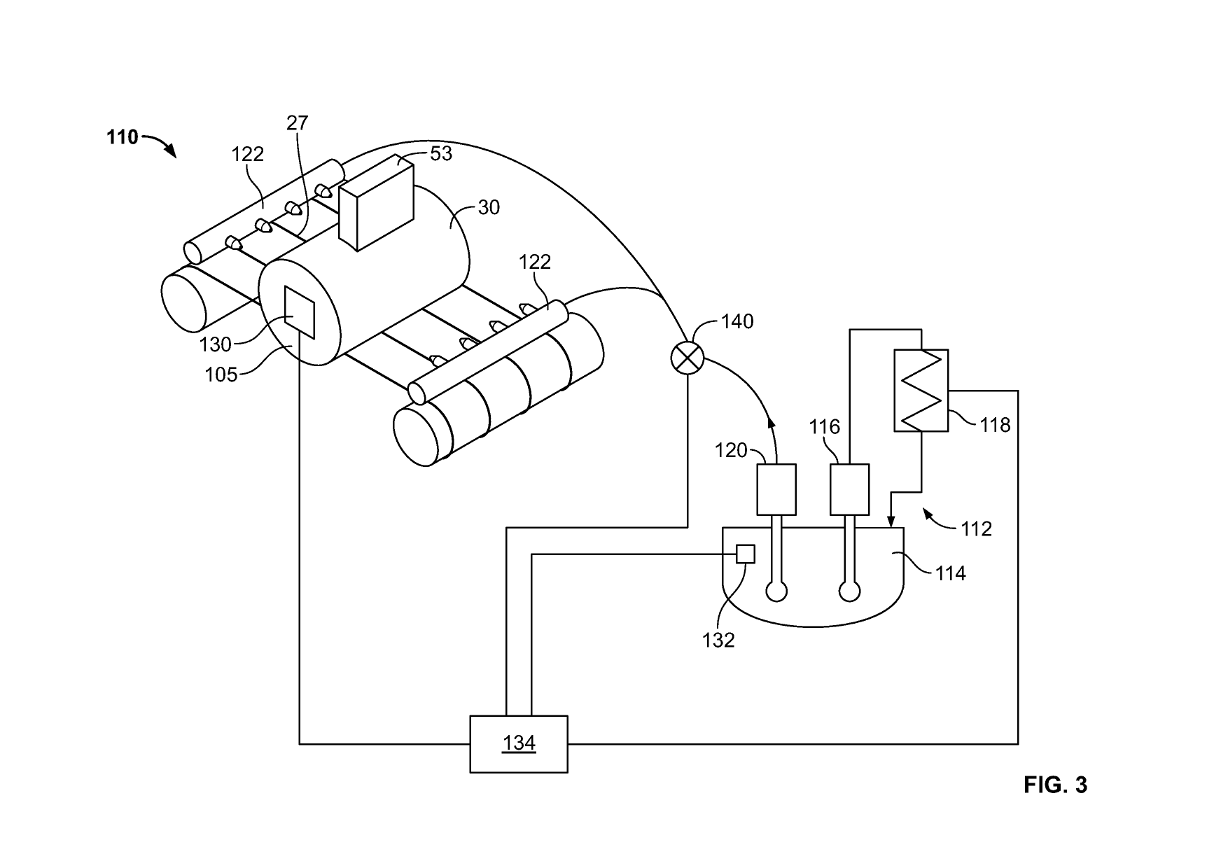

Referring to FIG. 3, an alternative system for controlling wafer surface profiles is indicated generally by the reference numeral 110. In the embodiment shown in FIG. 3, instead of using a heating device, slurry is heated to the top temperature of the ingot 30 (e.g., approximately 55° Celsius), and the heated slurry is then sprayed onto the ingot 30. To control the temperature of the cutting slurry, system 110 includes a slurry temperature control system 112.

In the slurry temperature control system 112, the slurry is stored in a slurry tank 114. To raise or lower the temperature of the slurry, a slurry temperature control pump 116 pumps slurry through a heat exchanger 118 and then back into the slurry tank 114.

To heat slurry, heat exchanger 118 is configured to transfer heat from a heating fluid (not shown) into slurry. To cool slurry, heat exchanger 118 is configured to transfer heat from slurry into a cooling fluid (not shown). While only one heat exchanger 118 is shown in FIG. 3, multiple heat exchangers 118 (e.g., one for heating the slurry and one for cooling the slurry) may be utilized by the temperature control system 112. Accordingly, using heat exchanger 118, the temperature of slurry in slurry tank 114 can be raised or lowered.

A slurry feed pump 120 pumps heated slurry from slurry tank 114 to one or more nozzles 122, which spray the heated slurry onto the surface of ingot 30. In this example embodiment, the heated slurry is applied to the surface of the ingot 30 before slicing, and also applied at least during the initial slicing by the wire web 27 to ensure the temperature of the ingot 30 remains substantially constant throughout the slicing process. Alternatively, or additionally, nozzles 122 may also apply the temperature-controlled slurry to the wire web 27 for use as the cutting slurry.

Similar to system 100 (shown in FIG. 2), an ingot temperature probe 130 is coupled to the end face 105 of the ingot 30 to monitor the temperature of the ingot 30. Alternatively or additionally, a slurry temperature probe 132 monitors the temperature of the slurry in the slurry tank 114. A controller 134 communicatively coupled to the heat exchanger 118, ingot temperature probe 130, and the slurry temperature probe 132 receives signals from probes 130 and 132 indicative of the temperature of the ingot 30 and the slurry, respectively. The controller 134 can control the temperature of the slurry based on the received signals by controlling operation of the heat exchanger 118.

In the system 110, the temperature of the ingot 30 can also be controlled by adjusting the amount of heated slurry sprayed onto the ingot 30. Accordingly, in the example embodiment, slurry pumped from slurry feed pump 120 passes through a valve 140 before reaching nozzles 122. The controller 134 is communicatively coupled to the valve 140, and can control the valve 140 to adjust a flow rate of the slurry, controlling the temperature of the ingot 30.

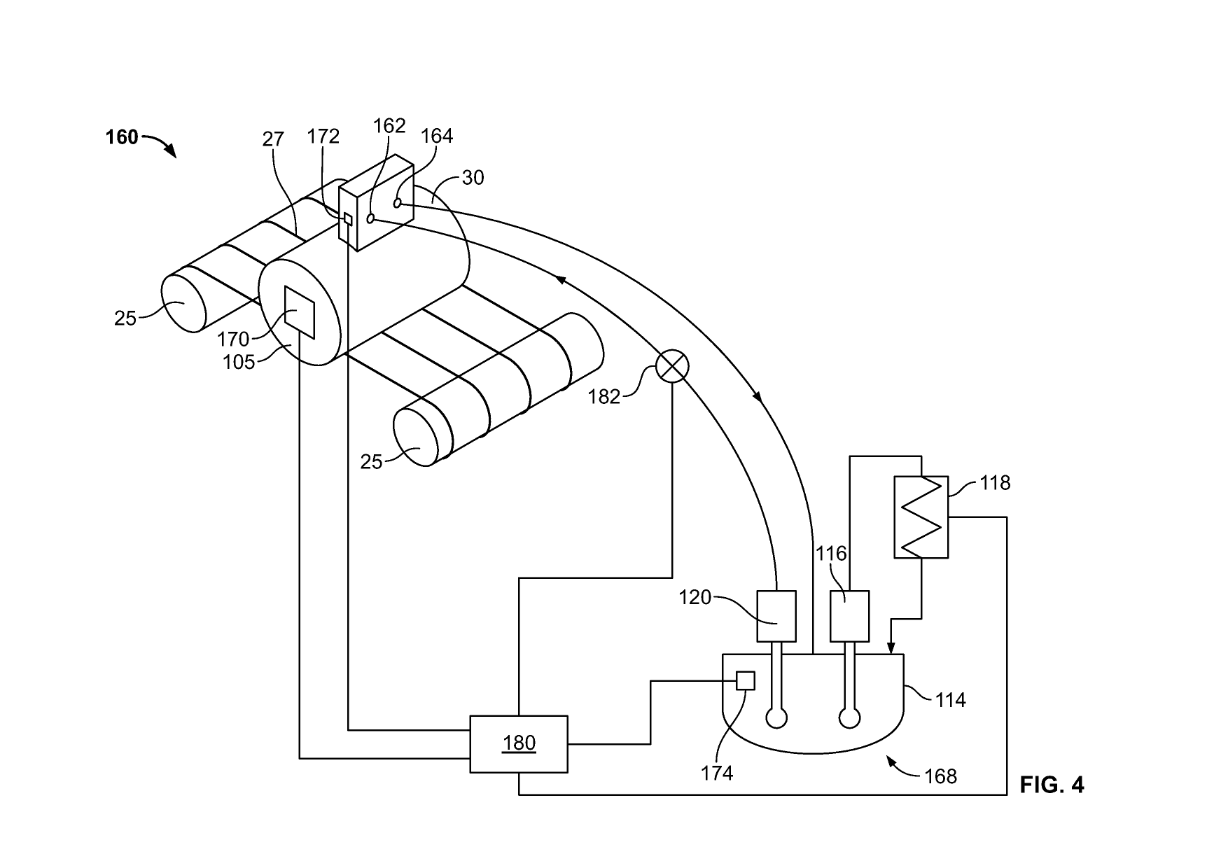

Referring to FIG. 4, an alternative system for controlling wafer surface profiles is indicated generally by the reference numeral 160. In the embodiment shown in FIG. 4, instead of heating the ingot 30, heat is transferred from the ingot 30 such that the temperature of the ingot 30 remains substantially constant during the slicing process.

In the embodiment shown in FIG. 4, a slurry channel is defined through the ingot holder 53. The slurry channel extends from a slurry inlet 162 to a slurry outlet 164. A slurry temperature control system 168, including components substantially similar to the slurry temperature control system 112 (shown in FIG. 3), provides cooled slurry to the channel.

Specifically, cooled slurry is pumped from the slurry tank 114 into the slurry inlet 162 and through the channel in the ingot holder 53. The slurry exits the ingot holder 53 at the slurry outlet 164, and in the example embodiment, is channeled back into the slurry tank 114. The slurry temperature control pump 116 and the heat exchanger 118 control the temperature of the slurry in the slurry tank 114, as described above.

As the cooled slurry flows through the channel, heat is transferred from the ingot holder 53 to the slurry, cooling the ingot holder 53. Through thermal contact with the cooled ingot holder 53, heat is transferred from the ingot 30 to the ingot holder 53. Accordingly, by sufficiently cooling the ingot holder 53 with cooled slurry, the temperature of the ingot 30, which would otherwise increase during the slicing process, may be held substantially constant. As explained above, by keeping the temperature of the ingot 30 substantially constant during the slicing process, surface defects in the produced wafers may be reduced.

Similar to system 100 (shown in FIG. 2), an ingot temperature probe 170 is coupled to the end face 105 of the ingot 30 to monitor the temperature of the ingot 30. Alternatively or additionally, an ingot holder temperature probe 172 may be coupled to the ingot holder 53 to monitor the temperature of the ingot holder, and a slurry temperature probe 174 monitors the temperature of the slurry in the slurry tank 114. A controller 180 communicatively coupled to the heat exchanger 118, the ingot temperature probe 170, the ingot holder temperature probe 172, and the slurry temperature probe 174 receives signals from probes 170, 172, and 174 indicative of the temperature of the ingot 30, the ingot holder 53, and the slurry in the slurry tank 114, respectively. The controller 180 can control the temperature of the slurry based on the received signals by controlling operation of the heat exchanger 118.

In the system 160, the temperature of the ingot 30 can also be controlled by adjusting the amount of cooled slurry flowing through the ingot holder 53. Accordingly, in the example embodiment, slurry pumped from the slurry feed pump 120 passes through a valve 182 before reaching the ingot slurry inlet 162. The controller 180 is communicatively coupled to the valve 182, and can control the valve 182 to adjust a flow rate of the cooled slurry, controlling the temperature of the ingot 30. In one example, the flow rate of the cooled slurry is 6 liters per minute (l/min). Alternatively, any flow rate that facilitates controlling the temperature of the ingot 30 may be used.

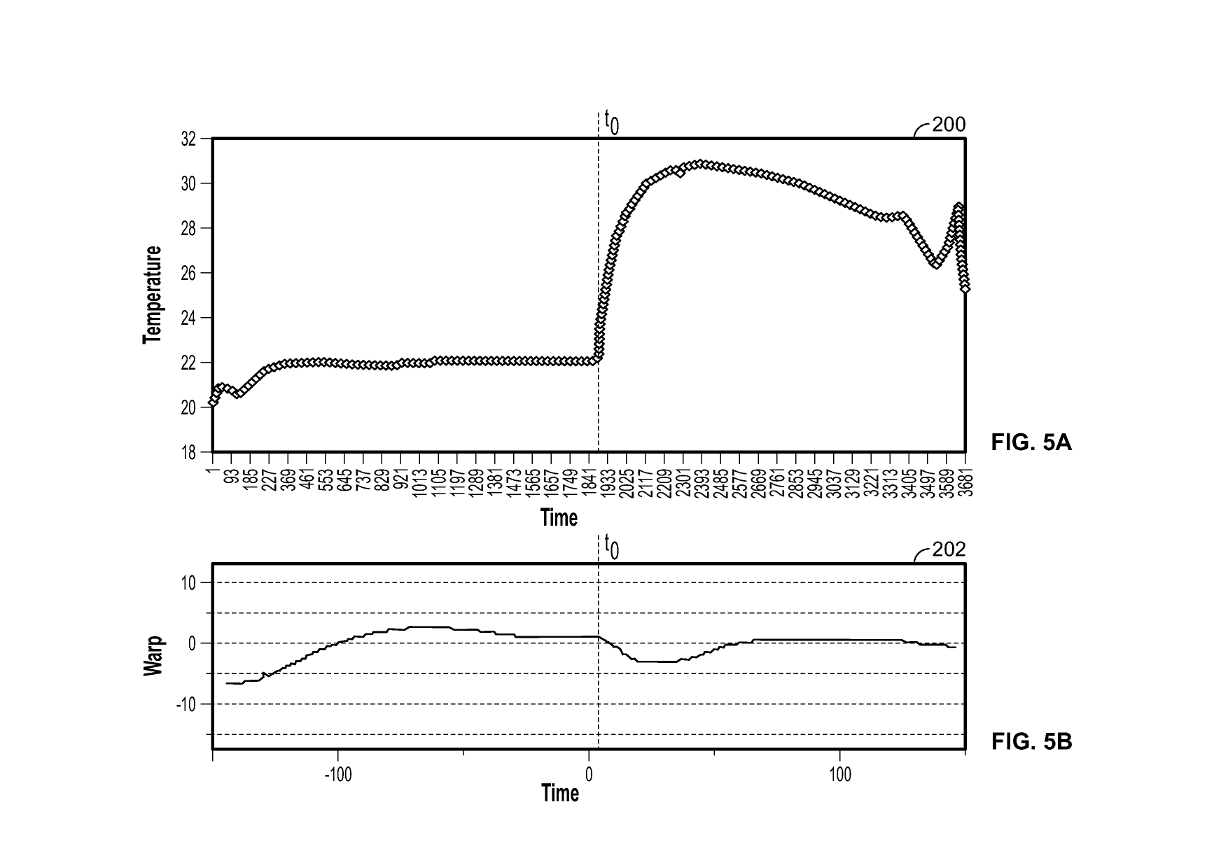

FIGS. 5A and 5B are graphs demonstrating the efficacy of the system 160 shown in FIG. 4. FIG. 5A is a graph 200 plotting a temperature of the ingot holder 53 versus time during the slicing process. FIG. 5B is a graph 202 plotting a degree of wafer warp versus time during the slicing process. Prior to a time t₀, the ingot holder 53 was cooled using cooled slurry. At time t₀, slurry stopped flowing through the ingot holder 53 (e.g., by closing the valve 182).

As shown in graph 200, at time t₀, the temperature of the ingot holder 53 increased, due to the absence of cooled slurry flowing therethrough. Further, as shown in graph 202, at time t₀, an increase in the degree of wafer warp was observed, in response to the temperature change of the ingot holder 53, and consequently, the ingot 30. Accordingly, channeling cooling slurry through the ingot holder 53 facilitates reducing surface defects, such as warp, in wafers produced from the ingot 30.

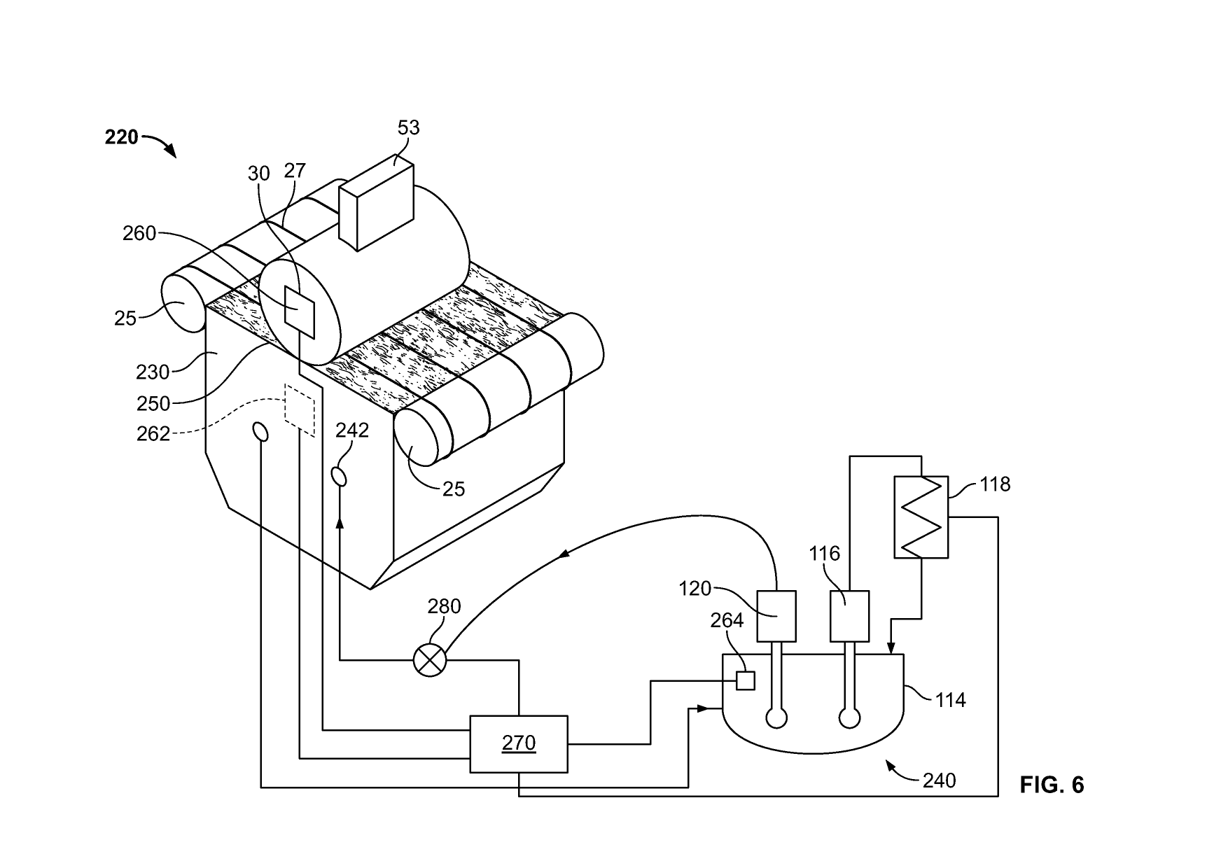

Referring to FIG. 6, an alternative system for controlling wafer surface profiles is indicated generally by the reference numeral 220. Using the system 220, instead of channeling cooled slurry through the ingot holder 53, heat is transferred from the ingot 30 by immersing at least a portion of the ingot 30 in cooled slurry.

In the embodiment shown in FIG. 6, a containment box 230 is located below (i.e., vertically beneath) the ingot 30. A slurry temperature control system 240, including components substantially similar to the slurry temperature control system 112 (shown in FIG. 3), provides cooled slurry to the containment box 230, which functions as a slurry reservoir. That is, the containment box 230 holds a volume of cooled slurry.

Specifically, cooled slurry is pumped from the slurry tank 114 into a slurry inlet 242 of the containment box 230. Slurry exits the containment box 230 at a slurry outlet 244, and in the example embodiment, is channeled back into the slurry tank 114. The slurry temperature control pump 116 and the heat exchanger 118 control the temperature of the slurry in the slurry tank 114, as described above. Accordingly, the slurry temperature control system 112 supplies the containment box 230 with a continuous supply of cooled slurry.

In the example embodiment, enough cooled slurry is provided to the containment box 230 such that a level of the cooled slurry within the containment box 230 reaches a top 250 of the containment box 230. If the level of the cooled slurry is higher than the top 250, any excess slurry flows over the top 250 and out of the containment box 230. Overflow slurry may be collected and returned to the slurry tank 114.

In system 220, the top 250 of the containment box 230 is located just below the wire web 27. Accordingly, the cooled slurry in the containment box 230 does not contact or otherwise interfere with the wire web 27 slicing the ingot 30.

As described above, the ingot 30 is lowered into the wire web 27 during the slicing process. Accordingly, after a portion of the ingot 30 passes through the wire web 27, that portion is submerged in the cooled slurry in the containment box 230. Submerging the ingot 30 in the cooled slurry shortly after it passes through the wire web 27 facilitates suppressing the temperature increase that would otherwise occur from the slicing, reducing surface defects in the wafers produced from the slicing process.

Similar to system 100 (shown in FIG. 2), an ingot temperature probe 260 is coupled to the end face 105 of the ingot 30 to monitor the temperature of the ingot 30. Alternatively or additionally, a containment box temperature probe 262 may be positioned within the containment box 230 to monitor the temperature of the cooled slurry in the containment box 230, and a slurry temperature probe 264 monitors the temperature of the slurry in the slurry tank 114.

A controller 270 communicatively coupled to the heat exchanger 118, the ingot temperature probe 260, the containment box temperature probe 262, and the slurry temperature probe 264 receives signals from probes 260, 262, and 264 indicative of the temperature of the ingot 30, the slurry in the containment box 230, and the slurry in the slurry tank 114, respectively. The controller 270 can control the temperature of the slurry based on the received signals by controlling operation of the heat exchanger 118.

In the system 220, the temperature of the ingot 30 can also be controlled by adjusting the amount of cooled slurry flowing into the containment box 230. Accordingly, in the example embodiment, slurry pumped from the slurry feed pump 120 passes through a valve 280 before reaching the slurry inlet 242. The controller 270 is communicatively coupled to the valve 280, and can control the valve 280 to adjust a flow rate of the cooled slurry, controlling the temperature of the cooled slurry in the containment box 230.

Multiple systems and methods to control (i.e., change, manipulate, adjust) the temperature of an ingot to control its expansion have been disclosed herein. By controlling the expansion of the ingot, it is believed that the defects in the surface of the wafers can eliminated or reduced and/or that the warp or shape of the wafers can be controlled.

When introducing elements of the present disclosure or the embodiments thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the present disclosure, it is intended that all matter contained in the above description and shown in the accompanying drawings shall be interpreted as illustrative and not in a limiting sense.

What is claimed is:

1. A system for controlling the surface profile of wafers sliced from an ingot in a wire saw, the wire saw including a wire guide supporting wires, the system comprising:
a containment box positioned vertically beneath the wires and configured to contain a slurry; and
a slurry temperature control system configured to circulate slurry through the containment box.

2. The system of claim 1, wherein the containment box is configured to immerse at least a portion of the ingot in the slurry after the at least a portion of the ingot passes through the wires.

3. The system of claim 2, wherein the containment box is configured to immerse the at least a portion of the ingot such that defects in the surface profile of the sliced wafers are reduced.

4. The system of claim 2, wherein the containment box is configured to immerse the at least a portion of the ingot such that a temperature of the at least a portion is decreased.

5. The system of claim 1, wherein the containment box comprises:
a slurry inlet configured to receive slurry from the slurry temperature control system; and
a slurry outlet configured to channel slurry from the containment box to the slurry temperature control system.

6. The system of claim 1, wherein the slurry temperature control system comprises:
a slurry tank;
a slurry feed pump configured to channel slurry from the slurry tank to the containment box;
a heat exchanger; and
a slurry temperature control pump configured to channel slurry through the heat exchanger to control a temperature of the slurry.

7. The system of claim 6, further comprising:
a temperature probe coupled within the slurry tank and configured to monitor a temperature of the slurry in the slurry tank; and
a controller communicatively coupled to the temperature probe and the heat exchanger, the controller configured to control a temperature of the slurry via the heat exchanger based on the monitored temperature.

8. The system of claim 1, further comprising:
a temperature probe coupled to the ingot and configured to monitor a temperature of the ingot; and
a controller communicatively coupled to the temperature probe and configured to control a temperature of the slurry based on the monitored temperature.

9. The system of claim 1, further comprising:
a temperature probe coupled within the containment box and configured to monitor a temperature of the slurry in the containment box; and
a controller communicatively coupled to the temperature probe and configured to control a temperature of the slurry based on the monitored temperature.

10. The system of claim 1, wherein the slurry temperature control system further comprises a valve configured to control a flow rate at which the slurry is circulated through the containment box.

11. A method for controlling the surface profile of wafers sliced from an ingot in a wire saw, the wire saw including a wire guide supporting wires, the method comprising:
circulating slurry through a containment box positioned vertically beneath the wires, the slurry circulated using a slurry temperature control system; and
immersing at least a portion of the ingot in the slurry after the at least a portion of the ingot passes through the wires.

12. The method of claim 11, wherein immersing the at least a portion of the ingot comprises immersing the at least a portion of the ingot such that defects in the surface profile of the sliced wafers are reduced.

13. The method of claim 11, wherein immersing the at least a portion of the ingot comprises immersing the at least a portion of the ingot such that a temperature of the at least a portion is decreased.

14. The method of claim 11, wherein circulating slurry through the containment box comprises:
channeling slurry from the slurry temperature control system to a slurry inlet of the containment box; and
channeling slurry from a slurry outlet of the containment box to the slurry temperature control system.

15. The method of claim 11, further comprising:
monitoring a temperature of the ingot using a temperature probe coupled to the ingot; and
controlling a temperature of the slurry based on the monitored ingot temperature.

16. The method of claim 11, further comprising:
monitoring a temperature of the slurry using a temperature probe coupled within the containment box; and
controlling a temperature of the slurry based on the monitored slurry temperature.

17. A system for controlling the surface profile of wafers sliced from an ingot in a wire saw, the wire saw including a wire guide supporting wires, the system comprising:
a slurry temperature control system; and
at least one nozzle in fluid communication with the slurry temperature control system and configured to spray slurry onto a surface of the ingot to facilitate reducing surface defects in the surface profile of the wafers sliced from the ingot.

18. The system of claim 17, wherein the at least one nozzle is configured to spray slurry onto the surface of the ingot such that the ingot is heated to approximately 55° Celsius before the ingot contacts the wires.

19. The system of claim 17, further comprising:
a temperature probe coupled to the ingot and configured to monitor a temperature of the ingot; and
a controller communicatively coupled to the temperature probe and configured to control a temperature of the slurry based on the monitored ingot temperature.

20. The system of claim 17, wherein the slurry temperature control system comprises:
a slurry tank;
a slurry feed pump configured to channel slurry from the slurry tank to the at least one nozzle;
a heat exchanger; and
a slurry temperature control pump configured to channel slurry through the heat exchanger to control a temperature of the slurry.
